(19) United States
(12) Patent Application Publication
(10) Pub. No.: US 2007/0198684 A1
(43) Pub. Date: Aug. 23, 2007

(54) Method and system for data processing with connection pool for the same

(76) Inventor: Kazunori Mizushima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/488,026

(22) Filed: Jul. 18, 2006

(30) Foreign Application Priority Data
Feb. 22, 2006 (JP) 2006-045264

(51) Int. Cl. G06F 15/173

(52) U.S. Cl. 709/223

(57) ABSTRACT

When an application server prepares the connection made to the database server, an identifier for definitely identifying the database server of connection destination is allotted to the connection. When a fault occurs in a database system, the database identifier of the connection is specified and only a connection allotted with the same identifier as the specified identification is discarded from a connection pool. When a request is received from a client computer, a connection is acquired from the connection pool. The acquired connection is decided as to whether to be faulty and if the acquired connection is determined as being faulty, a database server to be coupled to the faulty connection is specified by consulting connection management information. All connections made or coupled to the specified database server are discarded from the connection pool and a new connection is prepared.

### INCORPORATION BY REFERENCE

The present application claims priority from Japanese application JP2006-045264 filed on Feb. 22, 2006, the content of which is hereby incorporated by reference into this application.

### BACKGROUND OF THE INVENTION

The present invention relates to a computer system and more particularly, to a technique for managing connections to a database.

Available as a technique of improving the performance of connection between an application server and a database server in a database system is a connection pool technique. According to the connection pool technique, a plurality of connections are prepared in advance between, for example, the application server and the database server. Then, responsive to a request for acquisition of a connection from a user application, the application server uses a pooled connection. This can eliminate the necessity of, for example, establishing connection of a lower layer (for example, TCP connection) and authenticating a user each time that a request for coupling a connection is made and time required for accessing a database can therefore be shortened. The technique as above is disclosed in JP-A-2003-216477.

Also, as a database system improved in performance, a cluster database is available. The cluster database has a plurality of accessible database servers packaged in, for example, a common disk. A database distributor (for example, a load balancer) is interposed between each of the plural database servers and the application server. When receiving a request for connection to a database server from the application server, the database distributor distributes the access to any one of the database servers. Consequently, the application server can use a database efficiently without being conscious of which database server the application server is coupled to. This kind of technique is disclosed in JP-A-8-95841.

Accessing to the cluster database system based on the aforementioned connection pool technique encounters a problem that the access performance is degraded in the event of occurrence of a fault in a database server. More specifically, in the event that a fault takes place in one of the database servers constituting the cluster, a connection made to the faulty database server suffering the occurrence of a fault needs to be discarded from the pool.

In the cluster database system, however, the application server cannot presume any state of operation which proceeds after the phase of the database distributor and cannot have knowledge of which connection is made to which database server, failing to discriminate the pooled connections from one another. In consequence, a connection made to a faulty database server will sometimes be allotted in response to a request from the application server.

In such an event, the application server checks the allocated connection for its normality. If the application server determines that a fault occurs in the allocated connection to settle abnormality of the connection, all connections pooled at present cannot help being discarded. This accounts for the fact that the pooled connections cannot be discriminated from one another and hence recognition of which connection is made to which database server is impossible. Accordingly, much time is required for reestablishment of connection and the performance of access to the database is deteriorated.

### SUMMARY OF THE INVENTION

An object of the present invention is to minimize the degradation of the performance of access to databases even when a fault occurs in a database.

According to a typical embodiment of the present invention, in a database connection management method for use in a computer system having a database system provided with a plurality of database servers each including a database management system, an application server provided with a connection pool for retaining a plurality of connections to be made to the database system and operative to access the database system and a client computer for accessing the application server to receive an offer of business service, the database system stores in the application server a database server to be connected to the application server and then connects it to the application server, and the application server retains connection management information for specifying, when preparing a new connection, a database server coupled to the connection to be prepared and managing the specified database server and the prepared connection by making the correspondence therebetween.

In other words, when the application server identifies a database server corresponding to a connection and makes a connection to the database server, an identifier for definitely identifying the database sever of connection destination is given to the connection. Then, in the event that a fault occurs in that database system, the database identifier of the connection is specified and only the connection allotted with the same identifier as the specified identifier is discarded from the connection pool.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the construction of a computer system according to an embodiment of the present invention.

FIG. 2A is a diagram showing the construction of an application server.

FIG. 2B is a diagram also showing the construction of the application server to explain operation thereof.

FIG. 3A shows the structure of a connection management table.

FIG. 3B shows the structure of a table indicating marks indicative of marks of connections.

FIG. 4 is a flowchart of a connection acquisition process.

FIG. 5 is flowchart of a database blockade process.

FIG. 6 is a flowchart of a connection release process.

FIG. 7 is a flowchart of a database addition process.

FIG. 8 is a diagram explanatory of a screen displaying a connection management table.

FIG. 9 is a diagram showing the construction of a first modification of the computer system.

FIG. 10 shows the structure of a load information table in the first modification.

FIG. 11 is a flowchart of an unoccupied connection selection process in the first modification.

FIG. 12 is a diagram showing the construction of a second modification of the computer system.

FIG. 13 shows the structure of a connection management table in the second modification.

FIG. 14 is a flowchart of an unoccupied connection selection process in the second modification.

### DESCRIPTION OF THE INVENTION

According to an embodiment of the present invention, the degradation of the performance of access to databases can be minimized even in the event of occurrence of a fault in a database.

The invention will now be described by way of example with reference to the accompanying drawings.

### First Embodiment

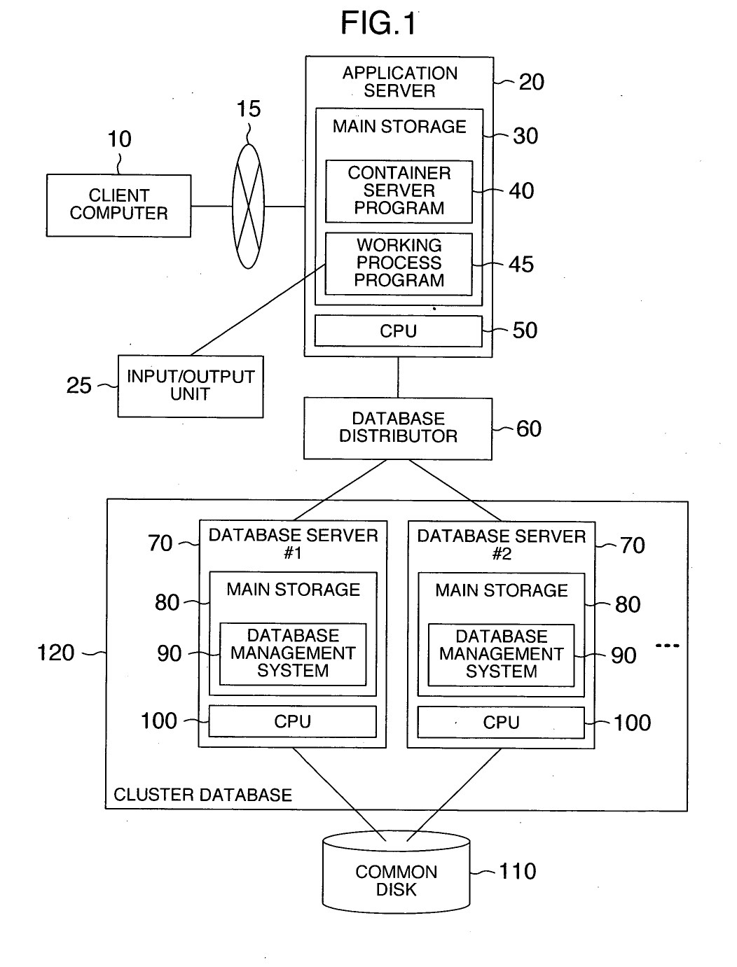

Referring first to FIG. 1, a computer system according to an embodiment of the present invention is constructed as schematically illustrated therein.

The computer system of the present embodiment comprises a client computer 10 a user uses, an application server 20 for making an offer of business service using a database, a cluster database 120 including a plurality of database servers 70, a database distributor 60 for distributing accesses to the database servers 70 and a common disk 110 the database servers 70 access.

The client computer 10 is connected to the application server 20 through a network 15. The network 15 is a data transferable communication path which is, for example, an LAN (local area network) or Internet using TCP/IP protocol, a radio communication network or a wired communication network (for example, PSTN).

The client computer 10 is a computer including a processor (CPU), a main storage (memory), a communication interface and an input/output unit, these components being coupled together by way of an internal bus. The client computer 10 operates a client program (web browser), for example, to present a business service offered by the application server 20 to the user. While in FIG. 1 the single client computer 10 is illustrated, a plurality of client computers 10 may be provided.

The application server 20 is a computer including a processor (CPU) 50, a main storage 30, a communication interface (not illustrated) and an input/output unit 25. While in FIG. 1 the single application server 20 is illustrated, a plurality of application servers 20 may alternatively be provided.

The processor 50 is a processing unit for performing operations concerning various programs executed by the application server 20.

The main storage 30 is a memory for storing programs necessary for operation of the processor 50 and data. Especially, in the present embodiment, the main storage 30 stores container server program 40 and working process program 45 which are executed in the application server 20.

The container sever program 40 is a program on which a user application program operates. The working process program 45 is a program necessary for working the application server and includes drivers for various components (for example, the input/output unit 25).

The communication interface of client computer 10 is connected to the application server 20 via the network 15 to transmit/receive data to/from the application server 20. The input/output unit 25 is such a unit as a keyboard or display unit which provides a user interface.

The cluster database 120 includes the plural database servers 70 and deals with accesses distributed by the database distributor 60.

The database server 70 is a computer having a processor (CPU) 100, a main storage 80 and a communication interface (not shown).

The processor 100 is a processing unit for performing operations concerning various programs executed by the database server 70.

The main storage 80 is a memory for storing programs necessary for operation of the processor 100 and data. Especially, in the present embodiment, the main storage 80 stores a database management system (DBMS) executed in the database server 70.

The database management system manages data stored in the common disk 110 and reads data requested by the application server 20 out of the common disk to give it to the application server 20.

The communication interface of application server 20 is connected to the database distributor unit 60 to transmit/receive data to/from the application server 20.

The database distributor 60 is materialized with a drive program employed for specifying a database server 70 of access destination and distributing an access from the application server 20 to that database server 70. It will be appreciated that the database distributor 60 may alternatively be a load distributor adapted to monitor a loading state of each database server 70 and distribute accesses from the application server 20 in such a manner that loads on the database servers 70 can be uniformized.

To add, the database distributor 60 can be an independent unit but it may otherwise be included in either the application server 20 or a specified database server 70.

The application server 20, database distributor 60 and database servers 70 are interconnected by means of a communication path. The communication path is a network suited for communication of large-capacity data and for example, uses an SAN (Storage Area Network) implementing communication based on FC (Fiber Channel) protocol or an IP-SAN implementing communication pursuant to iSCSI (Internet SCSI) protocol.

The common disk 110 is a storage provided with a disk drive and a disk controller. The common disk 110 may have a plurality of disk drives to constitute an RAID (Redundant Array of Independent Disks), thereby giving redundancy to data to be stored. With this construction, even in the event that part of the drive disks becomes faulty, extinguishment of the stored data can be avoided to thereby ameliorate the reliability of common disk 110.

The common disk 110 is connected to the individual database servers 70 and is accessible from each database server 70. A communication path for connecting the common disk 110 and each of the database servers 70 is a network suitable for communication of large-capacity data and uses an SAN (Storage Area Network) or IP-SAN, for instance.

It will be appreciated that the computer system may incorporate a management computer used in order for a custodian to operate the database servers 70 and common disk 110.

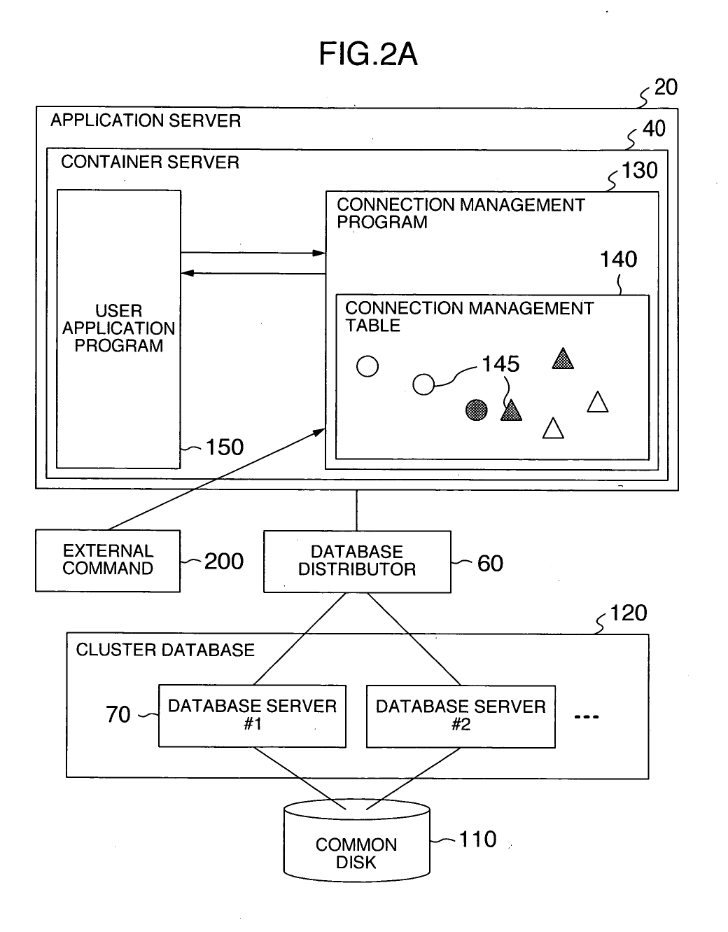

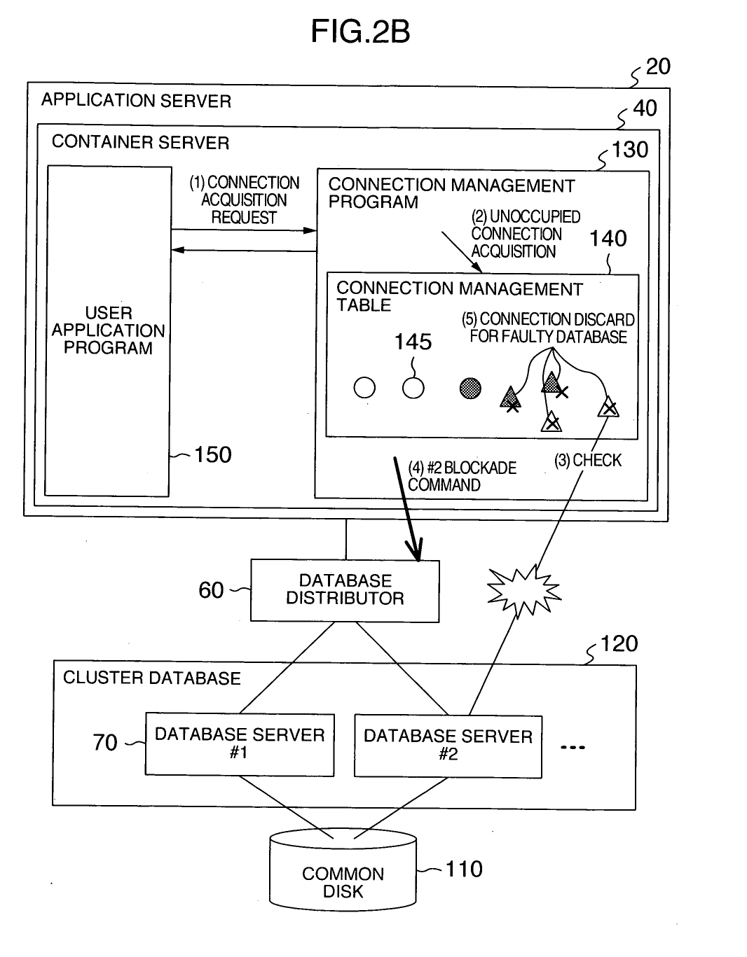

Turning to FIG. 2A, the application server 20 in the present embodiment is constructed as illustrated therein, showing operation of the container server 40 during normal operation.

On the container server 40, a user application program 150 and a connection management program 130 are operating.

The container server program 40 is a program on which the user application program operates and is for example a servlet or an EJB (Enterprise JavaBeans).

The user application program 150 is a program for offering to the client computer 10 a business service using a database.

The connection management program 130 manages connection between the application server 20 and the database server 70. More specifically, connection of lower layer (for example, TCP connection) is set up between the application server 20 and the database server 70 and a plurality of connections for which authentication by the application server 20 is completed are set. Then, the thus set connections 145 are recorded on the connection management table 140.

In FIG. 2A, the plural connections are indicated by marks. In the figure, an unoccupied connection is indicated in white and a connection in use is indicated in black. A circular mark indicates a connection made to a database server #1 and a triangular mark indicates a connection made to a database server #2.

Responsive to a connection acquisition request from the user application program 150, the connection management program 130 retrieves the connection management table 140 to select an unoccupied connection. Then, information of the selected connection is transmitted to the user application program 150.

In addition, responsive to a command 200 inputted from the input/output unit 25, the connection management program 130 executes processes of setting and waiving a connection, blocking and adding a database server and displaying the connection management table 140.

The construction of application server 20 in the present embodiment is also illustrated in FIG. 2B to show operation of container server 40 in the event of occurrence of a fault.

When receiving an access from the client terminal 10, the user application program 150 makes a request to the connection management program 130 for acquisition of a connection in order to access a database as indicated at (1) in the figure. Responsive to the connection acquisition request from the user application program 150, the connection management program 130 retrieves the connection management table 140 to select an unoccupied connection as indicated at (2). Thereafter, the connection management program 130 checks the selected connection 145 for its faultiness (soundness) as indicated at (3).

If the connection 145 is determined to be faulty, the connection management program 130 commands the database distributor 60 to block a database server 70 connected with the faulty connection 145 as indicated at (4). Subsequently, the connection management program 130 retrieves the connection management table 140 and specifies the connection 145 coupled to the blocked database server 70 to put away the specified connection 145 as indicated at (5). This discard of the connection is also termed deletion.

Thereafter, the connection management program 130 sets a new connection 145 and transmits it to the user application 150.

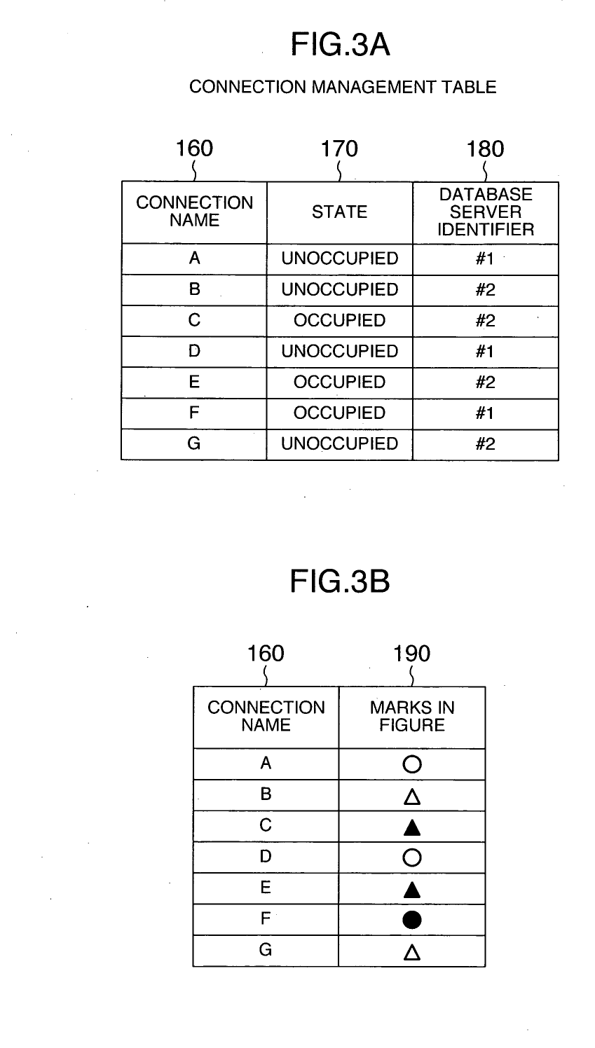

The structure of connection management table 140 in the present embodiment will be described with reference to FIG. 3A.

The connection management table 140 includes cell items of connection name 160, connection state 170 and database server identifier 180.

Under the connection name 160, an identifier for definitely identifying a connection 145 is entered. Under the connection state 170, an indication is given as to whether the connection 145 is occupied or unoccupied. Under the database server identifier 180, an identifier for definitely identifying a database server 70 coupled with the connection 145 is entered.

Illustrated in FIG. 3B is the structure of a table showing marks indicative of the connections in the present embodiment.

The table showing marks indicative of the connections includes cell items of connection name 160 and mark 190 in the figure. Under the mark 190, entries of marks depicted in the figure are indicated. It is to be noted that the table showing marks of connections may be formed integrally with the connection management table 140.

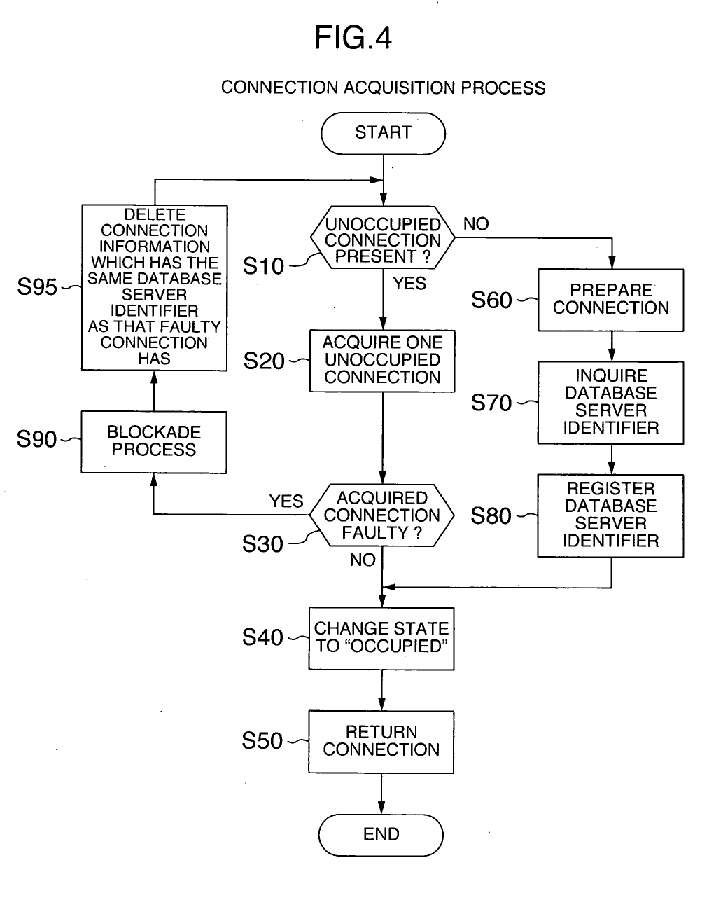

Referring now to FIG. 4, there is illustrated a flowchart of a connection acquisition process pursuant to the connection management program 130 in the present embodiment. The connection acquisition process is executed with the processor 50 of application server 20.

Firstly, when receiving a connection acquisition request from the user application 150, the connection management program 130 retrieves the connection management table 140 to decide whether a connection having its state 170 being “unoccupied” exists (S10).

If the result of decision determines the presence of at least one connection being “unoccupied”, one unoccupied connection is acquired (S20). Next, the thus acquired connection is decided as to whether to be faulty (S30). To describe more specifically, a database command imposing a less processing burden is transmitted to a database server 70 and depending on whether a normal return response is transmitted from the database server 70, the database server 70 is decided as to whether to be faulty, thus deciding the connection as to whether to be faulty.

If the result determines that the thus acquired connection is not faulty, the state 170 of the acquired connection in the connection management table 140 is changed to “occupied” (S40) and information of the thus acquired connection is transmitted to the user application program 130 (S50).

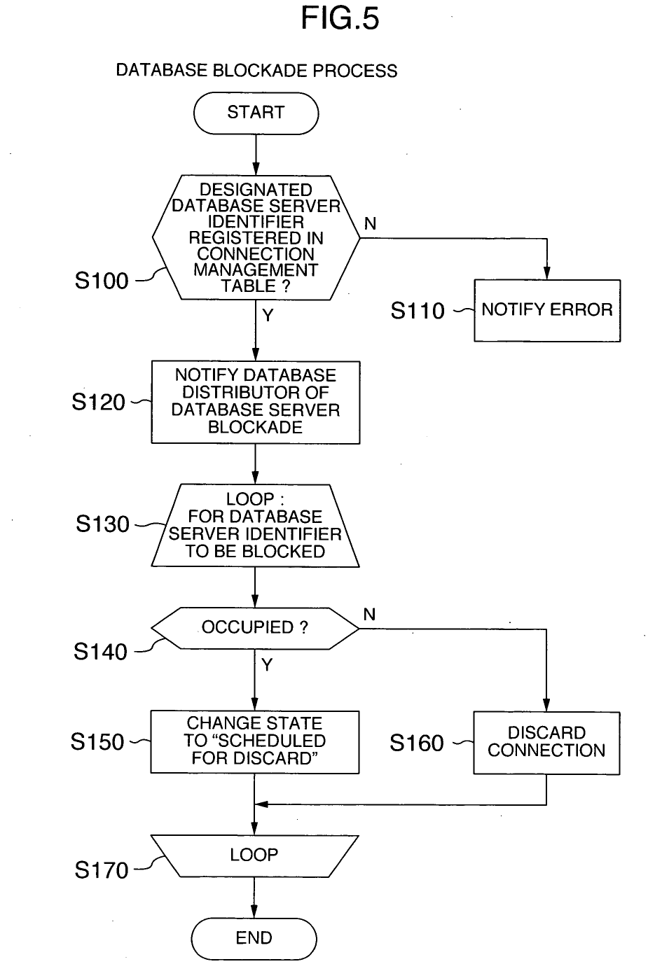

On the other hand, if the result determines that the acquired connection is faulty, the connection management table 140 is consulted to acquire an identifier of a database server 70 coupled with the connection determined as being faulty. Then, the connection management program 130 commands the database distributor 60 to block the database 70 coupled with the connection determined to be faulty (S90). Subsequently, information of the connection having an identifier of the database server coupled with the connection determined as being faulty is deleted from the connection management table 140 (S95). It will be appreciated that before discarding the connection, it may be decided in the step S95 whether the connection is in use. This can be materialized similarly to, for example, a process covering steps S120 to S140 in FIG. 5.

On the other hand, if the absence of an unoccupied connection is determined in the step S10, the database distributor 60 is requested to prepare a new connection (S60). Then, a command for acquiring the state of a server is transmitted to a data server 70 via the prepared connection, inquiring a database identifier (S70). Then, a database server identifier 180 acquired from the database server 70 and a connection name 160 of the prepared connection are added to the connection management table 140.

By making reference to FIG. 5, a flowchart of a database blockade process pursuant to the connection management program 130 in the present embodiment will be described. The database blockade process is executed with the processor 50 of application server 20.

Firstly, when the connection management program 130 responds to an external command 200 from the input/output unit 25 to receive a command to block a database 70 for which a database server identifier is designated, it decides whether the designated database server identifier is registered in the connection management table 140 (S100).

If the result determines registration of the designated database server identifier in the connection management table 140, blockade of the database server 70 specified by the designated database server identifier is informed to the database distributor 60 (S120). Subsequently, for a connection having the identifier 180 of the database server to be blocked, a process covering steps S140 to S160 is executed reiteratively (S130 to S170).

More particularly, by consulting the database management table 140, state 170 of the connection allotted with the identifier 180 of the database server to be blocked is examined (S140). If the result indicates that the state 170 of the connection is “occupied”, the state 170 is changed to “scheduled for discard” (S150). Accordingly, when placing the occupied connection in condition “scheduled for discard” and putting away the connection after completion of its use, an error in the process pursuant to the user application can be avoided.

To add, even the connection in use may forcibly be discarded before the use of the connection ends. In this case, since the connection is discarded on the way in the user application process, an error will be caused.

On the other hand, if the connection state 170 is “unoccupied”, the connection is deleted from the connection management table (S160).

Incidentally, when it is not determined in the step S100 that the designated database server identifier is registered in the connection management table 140, an error is notified by means of the input/output unit 25. For example, in case a command to block a database allotted with a database server identifier of “#4” is received, an error message “There is no database #4 as designated.” is displayed on the display screen of input/output unit 25.

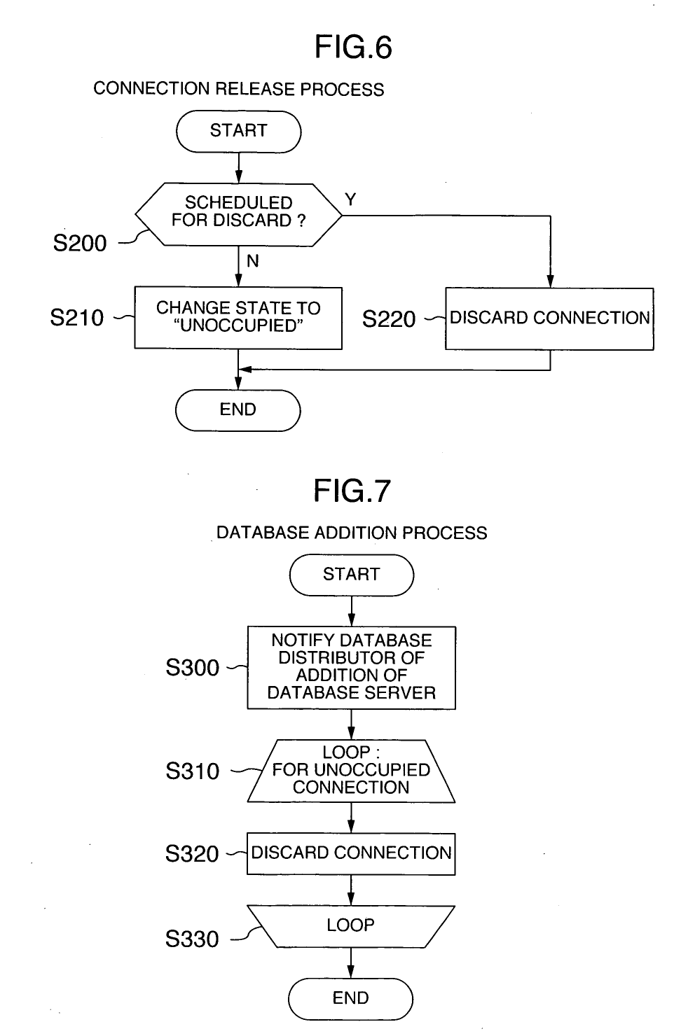

Illustrated in FIG. 6 is a flowchart of a connection release process based on connection management program 130 in the present embodiment. The connection release process is executed with the processor 50 of application server 20.

Firstly, when receiving a request for releasing a connection 145 from, for example, the user application 150, the connection management program 130 makes reference to the connection management table 140 so as to examine whether state 170 of the connection requested to be released is “scheduled for discard” (S200).

If the result determines that the state 170 of the connection requested to be released is not “scheduled for discard”, the state 170 is changed to “unoccupied” and the connection release process is ended (S210). On the other hand, if the state 170 of the connection requested for release is “scheduled for discard”, the connection is deleted from the connection management table 140 and is then put away (S220).

Illustrated in FIG. 7 is a flowchart of a database addition process by connection management program 130 in the present embodiment. The database addition process is executed with the processor 50 of application server 20.

Firstly, when receiving a notice of addition of a database 70 through an external command 200 or the like, the connection management program 130 informs the database distributor 60 of the addition of the database server 70 (S300).

Next, the connection management program 130 consults the database management table 140 so as to delete information of a connection whose connection state 170 is unoccupied from the connection management table 140 and discard the connection (S320). Subsequently, steps S310 to S330 are repeated until such a process is completed in respect of all unoccupied connections.

By discarding the unoccupied connections in the database addition process in this manner, connections made to the existing database servers are not selected but a connection made to a newly added database server can be selected preferentially, thereby making it possible to uniformize loads on the database servers within a short time.

In the step S320, only an unoccupied connection made to a highly-loaded database server is discarded, so that the load on the highly-loaded server can be decreased to uniformize loads on the database servers within a short time.

In alternative, reiteration of the steps S310 to S330 may not be executed for unoccupied connections but only notification (S300) to the database distributor 60 may be executed. In this case, by virtue of the load distributive function of database distributor 60, loads on the database servers inclusive of the newly added one can be unified.

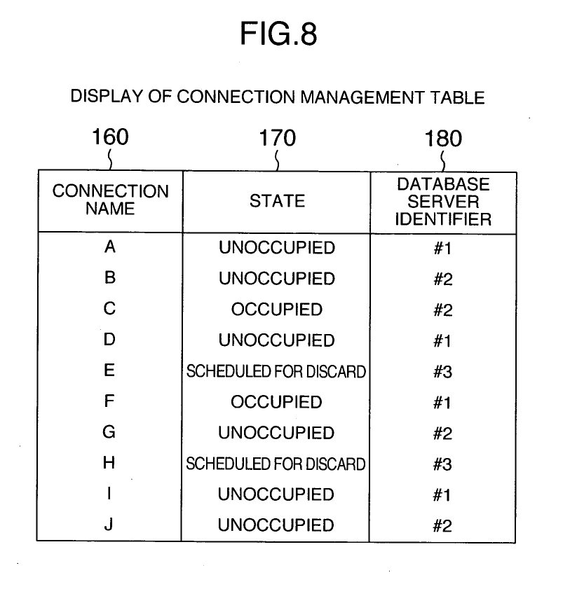

Referring to FIG. 8, a display screen of connection management table 140 in the present embodiment will be described.

When a command to display the connection management table is inputted from the input/output unit 25, the connection management program 130 causes the contents of connection management table 140 to be displayed on the input/output unit 25.

The display screen in FIG. 8 depicts the state different from that in the connection management table 140 shown in FIG. 3A.

### (First Modification)

In the present modification, when preparing a connection, the database distributor 60 distributes accesses to database servers by allowing for the loading conditions of respective database servers. Accordingly, as the connections are once prepared and managed in the pool inside application server 20, conditions of loading on the database servers are rendered to be unconsidered.

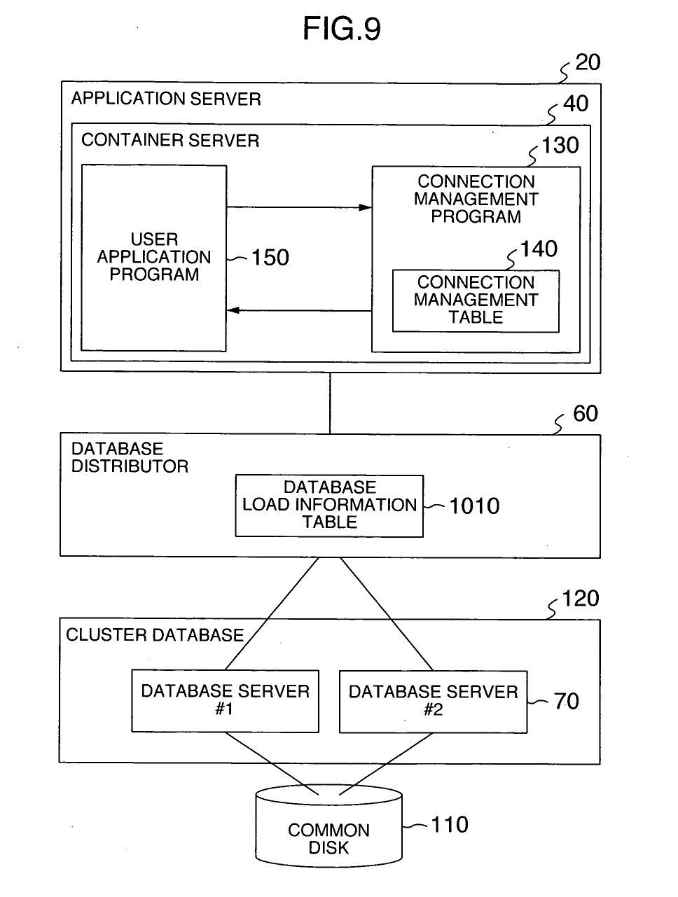

In addition, as shown in FIG. 9, a database load information table 1010 may be packaged in the database distributor. With the database distributor permitted to manage the database load information table 1010 in this manner, loads can be distributed by considering the loading conditions of the database servers in the cluster database system even after connection to the database server has been established. The first modification to this effect will now be described in greater detail.

The computer system according to the first modification is constructed as illustrated in FIG. 9. The database distributor 60 retains and manages the database load information table 1010.

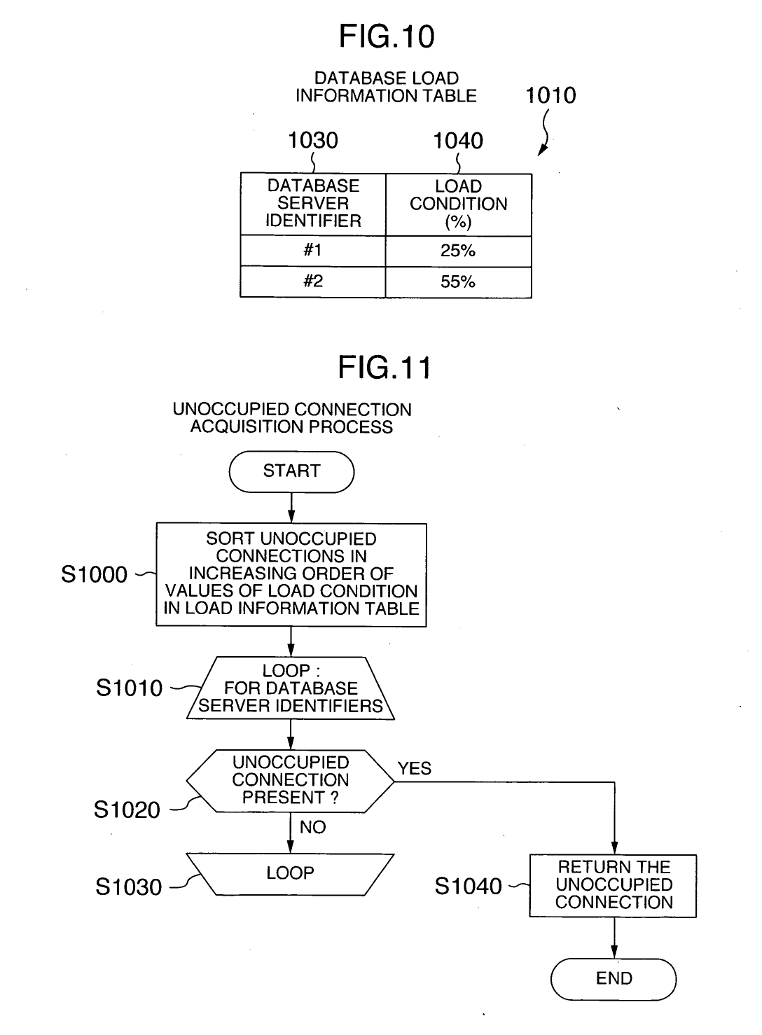

Illustrated in FIG. 10 is the structure of database load information table 1010 in the first modification.

The database load information table 1010 includes cell items of database server identifier 1030 and load condition 1040. Entered under the database server identifier 1030 is an identifier for definitely identifying a database server 70 to which a connection is made. The same information as that of the database server identifier 180 in connection management table 140 is used for this identifier. The load condition 1040 is expressed in terms of percentage and 100% signifies the highest load.

Illustrated in FIG. 11 is a flowchart of an unoccupied connection acquisition process in the first modification, which process is executed in the step S20 in the connection acquisition process (FIG. 4).

Firstly, pieces of data stored in the load information table 1010 are sorted in incremental order of values of load condition 1040 (S1000). Next, it is decided in sorting order as above whether unoccupied connections are present (S1020). In the presence of an unoccupied connection, information of the connection is transmitted to the user application program 130 (S1040). The decision process in the step S1020 is reiteratively executed in respect of database server identifiers in sorting order as above (S1010 to S1030).

As described above, according to the first modification, when an unoccupied connection is returned, the dynamic load conditions of the database servers are consulted to assure preferential allotment of a process to a lower-loaded database server and loads can be balanced among the individual database management systems.

### (Second Modification)

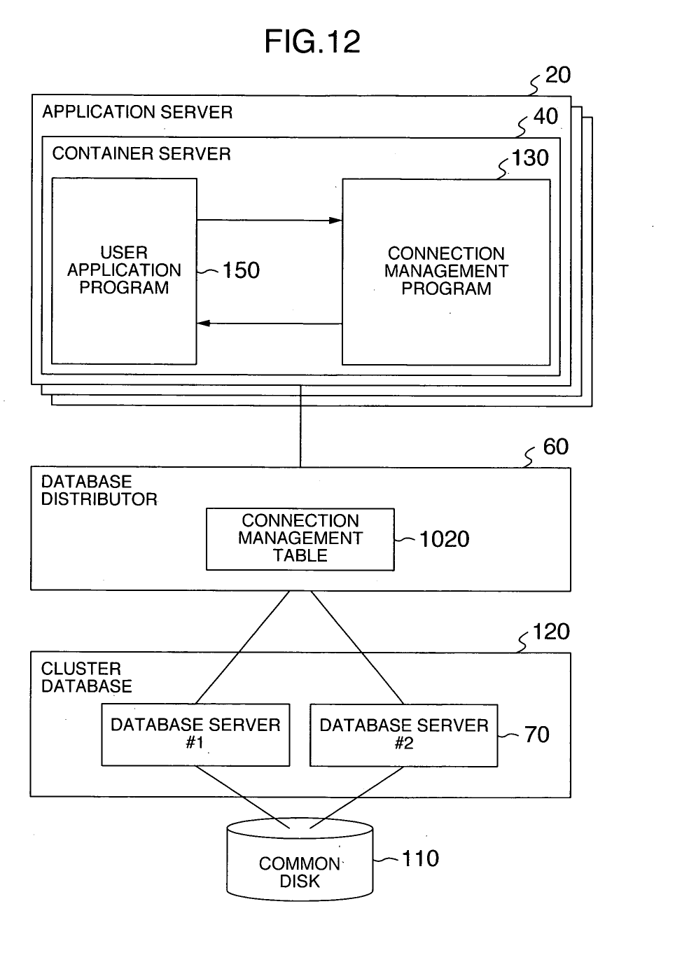

To make full use of various cache functions of the database, the same process as the precedently executed application may preferably be dealt with by the same database server. Therefore, according to the present modification, a connection management table 1020 is incorporated in the database distributor as shown in FIG. 12. Then, information of an identifier of the precedently executed application server is added to the connection management table 1020, thus improving the hit rate of database cache. The second modification will now be detailed.

A computer system in the second modification is constructed as shown in FIG. 12. The database distributor 60 retains and manages the connection management table 1020.

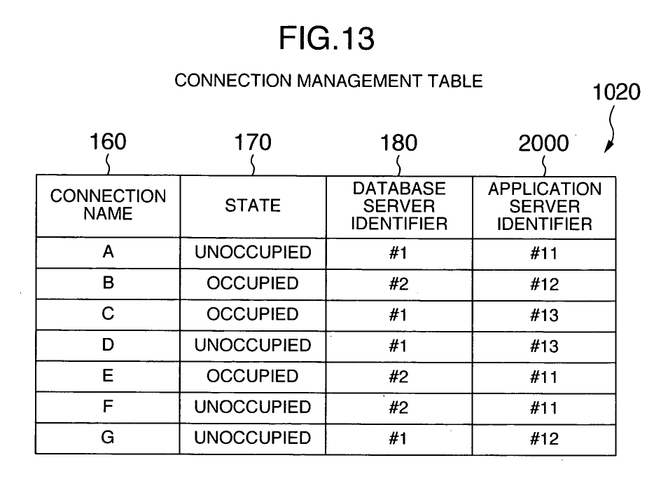

The structure of connection management table 1020 in the second modification is shown in FIG. 13.

The connection management table 1020 in the second modification includes cell items of connection name 160, connection state 170, database server identifier 180 and application server identifier 2000. The connection name 160, connection state 170 and database server identifier 180 are counterparts in the connection management table 140 shown in FIG. 3.

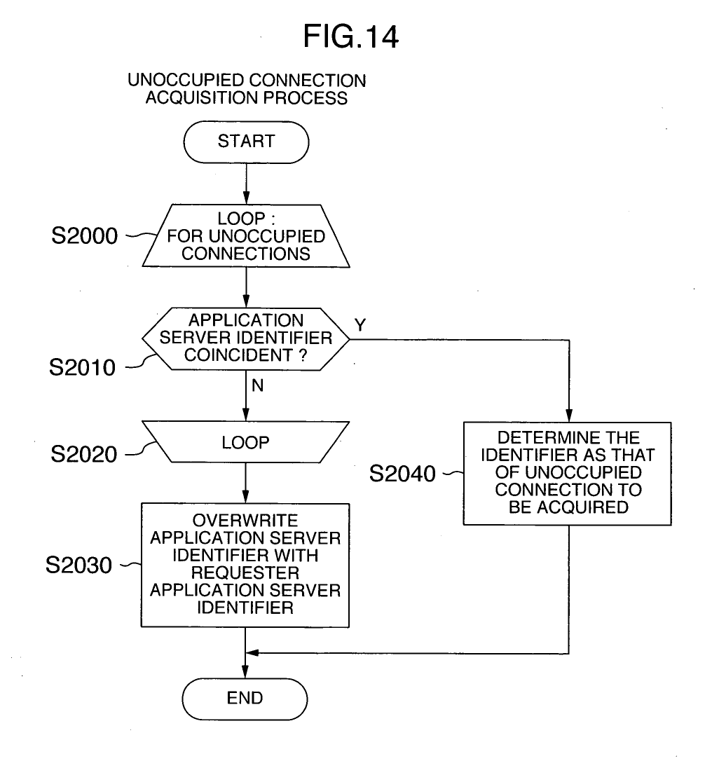

Illustrated in FIG. 14 is a flowchart of an unoccupied connection acquisition process in the second modification, which process is executed in the step S20 in the connection acquisition process (FIG. 4).

Firstly, in respect of an unoccupied connection, it is decided whether an identifier of an application server by the requester coincides with an application server identifier 2000 in the connection management table 1020 (S2010). If the result of decision indicates coincidence, information of the connection is transmitted to the user application program 130 (S2040). The decision process in the step S2010 is reiteratively executed for all unoccupied connections (S2000 to S2020).

In case the same identifier as that mentioned above is not owned by any of all the unoccupied connections, an arbitrary unoccupied connection is selected and an application server identifier 2000 corresponding to that connection is overwritten with the identifier of the requester application server (S2030).

Through the above process, the same application server is allowed to use the same connection.

In the second modification, the connection is managed in this manner and therefore when a fault in the database is detected by managing the connection, the plural application servers can manage connections made to the database server subject to occurrence of fault and therefore each application server having a connection made to the faulty database server can receive a transmitted command to delete the faulty connection. Through the process as above, connections made to the faulty database server can all be deleted.

It should be further understood by those skilled in the art that although the foregoing description has been made on embodiments of the invention, the invention is not limited thereto and various changes and modifications may be made without departing from the spirit of the invention and the scope of the appended claims.

1. A database connection managing method for use in a computer system having a database system provided with a plurality of database servers each including a database management system, an application server provided with a connection pool for retaining a plurality of connections to be made to the database system and operative to access said database system, and a client computer for accessing said application server to receive an offer of business service, wherein
said database system stores said database server to be connected to said application server within said application server and said database system makes connection to said application server; and
said application server retains connection management information for specifying, when preparing a new connection, a database server to be connected to the prepared connection and managing said specified database server and said prepared connection by making the correspondence therebetween.

2. A database connection managing method according to claim 1, wherein when receiving a request from said client computer, said application server acquires a connection from said connection pool, decides whether said acquired connection is faulty, and when said acquired connection is determined to be faulty, consults said connection management information to specify a database server to be coupled with said faulty connection, discards all connections to be made to said specified database server from said connection pool and prepares a new connection.

3. A database connection managing method according to claim 1, wherein when receiving a request for blocking a database server, said application server consults said connection management information to decide whether a connection made to said database server to be blocked is occupied, and when the result of decision indicates that said connection is occupied, sets the state of said connection in said connection management information to “scheduled for discard” but with the unoccupied state of said connection determined, discards said connection.

4. A database connection managing method according to claim 3, wherein when receiving the request for blocking a database server, said application server decides whether said database server to be blocked is registered in said connection management information, and if the result of decision does not indicate that said database server to be blocked is registered, notifies an error.

5. A database connection managing method according to claim 3, wherein when receiving a request for releasing a connection, said application server consults said connection management information to decide whether the state of the connection to be released is scheduled for discard, and if the result of decision determines that the state of said connection to be released is scheduled for discard, discards said connection but if the state of said connection to be released is not scheduled for discard, changes the state of said connection to “unoccupied”.

6. A database connection managing method according to claim 1, wherein said application server includes a display unit for displaying said connection management information.

7. A database connection managing method according to claim 1, wherein when receiving a request for adding a database server, said application server consults said connection management information to specify unoccupied connections and discards one of said specified unoccupied connections which is coupled to a highly-loaded database server.

8. An application server comprising:
a processor for performing operation processes;
a memory connected to said processor; and
a communication interface connected to said processor, wherein
said application server responds to an access from a client computer receiving an offer of business service from said application server to access a database system including a plurality of database servers;
said database system includes a database management system, so that a database server connected to said application server may be memorized in said application server and connects said database server to said application server; and
said application server includes a connection pool for retaining a plurality of connections made to said database system, and wherein
said processor retains connection management information for specifying, when preparing a new connection, a database server connected to the prepared connection and managing said specified database server and said prepared connection by making the correspondence therebeteen.

9. A program for causing an application server having a processor adapted to perform operation processes, a memory connected to said processor and a communication interface to manage connection to a database,
wherein said application server includes a connection pool for retaining a plurality of connections made to said database system and responds to an access from a client computer receiving a business service from said application server to select a connection from said connection pool;
wherein said database system includes a plurality of database servers each having a database management system, with a database server to be connected to said application server being memorized in said application server for connection thereto; and
wherein said program causes said application server to execute a step of specifying, when said application server prepares a new connection, a database server coupled to the prepared connection and a step of retaining connection management information for managing said specified database server and said prepared connection by making the correspondence therebetween.

10. A computer system comprising a database system having a plurality of database servers and a distributor, an application server for making an access to said database system and a client computer for accessing said application server to receive an offer of business service,
wherein said application server includes a processor for performing operation processes, a memory connected to said processor, a communication interface connected to said processor and a connection pool for retaining a plurality of connections to be coupled to said database system;
wherein said database system includes a distributor for distributing accesses to said plurality of database servers to each of them;
wherein said distributor distributes accesses to said plurality of database servers by causing a database server subject to coupling to be memorized in said application server and by coupling it to said database server;
wherein said database server includes a processor for performing operation processes, a memory connected to said processor and a communication interface coupled to said processor;
wherein said processor of database server executes a database management system; and
wherein said processor of application server retains connection management information for specifying, when preparing a connection, a database server to be coupled to the prepared connection and managing said specified database server and said prepared connection by making the correspondence therebetween.

11. A database connection managing method according to claim 1, wherein said computer system includes a connection unit for relaying an access to said database system from said application server, said connection unit monitors a load on said database server and retains information on the load acquired through monitoring, and said application server consults, when receiving a request from said client computer, the load information retained in said connection unit to preferentially acquire a connection for a lower-loaded database server from said connection pool.

12. A database connection managing method according to claim 1, wherein said computer system includes a connection unit for relaying an access to said database system from said application server, said connection unit monitors the state of occupation of a connection by said application server to retain connection occupation information acquired through monitoring, and said application server consults, when receiving a request from said client computer, the connection information retained in said connection unit to acquire the same connection as used by said application server from said connection pool.

13. A computer system according to claim 10, wherein said application server includes:
means for acquiring a connection from said connection pool when receiving a request from said client computer;
means for deciding whether said acquired connection is faulty; and
means for consulting, when said acquired connection is determined to be faulty, said connection management information to specify a database server to be coupled to said faulty connection, discarding all connections to be coupled to said specified database server from said connection pool and preparing a new connection.

14. A computer system according to claim 13, wherein said application server includes:
means for consulting, when receiving a request for blocking a database server, said connection management information to decide whether a connection to be coupled to said database server to be blocked is occupied; and
means for setting the state of said connection in said connection management information to “scheduled for discard” when the result of decision indicates that said connection is unoccupied but discarding said connection when said connection is occupied.

15. A computer system according to claim 14, wherein said application server includes:
means for deciding, when receiving a request for blocking a database server, whether the database server to be blocked is registered in said connection management information; and
means for notifying an error when the result of decision indicates that said database server to be blocked is not registered.

16. A computer system according to claim 15, wherein said application server includes:
means for consulting, when receiving a request for releasing a connection, said connection management information to decide whether the state of the connection to be released is scheduled for discard; and
means for discarding said connection when the result of decision indicates that the state of the connection to be released is schedule for discard but changing the state of the connection to “unoccupied” when the state of the connection to be released is not scheduled for discard.

17. A computer system according to claim 10, wherein said application server includes:
means for acquiring, when receiving a request from said client computer, a connection from said connection pool;
means for deciding whether said acquired connection is faulty; and
means for consulting, when said connection is determined to be faulty, said connection management information to specify a database server coupled to said faulty connection, discarding all connections made to said specified database server and preparing a new connection.

18. A program according to claim 9, wherein said program causes said application server to execute the steps of:
consulting, when receiving a request for blocking a database server, said connection management information to decide whether the connection made to the database server to be blocked is occupied; and
setting the state of said connection in said connection management information to “scheduled for discard” when the result of decision indicates that said connection is occupied but discarding said connection when said connection is determined to be unoccupied.

19. A program according to claim 18, wherein said program causes said application server to execute the steps of:
deciding, when receiving a request for blocking a database server, whether said database server to be blocked is registered in said connection management information; and
notifying an error when the result of decision indicates that said database server to be blocked is not registered.

20. A program according to claim 19, wherein said program causes said application server to execute the steps of:
consulting, when receiving a request for releasing a connection, said connection management information to decide whether the state of the connection to be released is scheduled for discard; and
discarding said connection when the result of decision indicates that the state of said connection to be released is scheduled for discard but changing the state of said connection to “unoccupied” when the state of said connection to be released is not scheduled for discard.
